(19) United States
(12) Patent Application Publication
(10) Pub. No.: US 2026/0098183 A1
(43) Pub. Date: Apr. 9, 2026

(54) RELEASE AGENT AND LUBRICANT COMPOSITION, METHOD FOR FORMING COATING FILM, AND DRY COATING FILM

(71) Applicant: YUSHIRO CHEMICAL INDUSTRY CO., LTD., Tokyo (JP)

(72) Inventors: Mikinori Suzuki, Koza-gun, Kanagawa (JP); Keiji Izawa, Koza-gun, Kanagawa (JP); Makoto Ishikawa, Koza-gun, Kanagawa (JP); Hirokazu Takagi, Koza-gun, Kanagawa (JP)

(73) Assignee: YUSHIRO CHEMICAL INDUSTRY CO., LTD., Tokyo (JP)

(21) Appl. No.: 19/113,516

(22) PCT Filed: Mar. 17, 2023
(86) PCT No.: PCT/JP2023/010640

§ 371 Date: Mar. 20, 2025

(30) Foreign Application Priority Data
Sep. 21, 2022 (JP) 2022-150403

(51) Int. Cl. C09D 183/04; C09D 7/65

(52) U.S. Cl. CPC C09D 183/04; C09D 7/65

(57) ABSTRACT

A release agent and lubricant composition which exhibits excellent lubricity and release properties, exhibits high heat resistance, prevents seizure between a material to be processed and a mold, and exhibits good release properties between a material to be processed and a mold even if molding process is carried out repeatedly. This release agent and lubricant composition is characterized by comprising a silicone resin comprising a T-unit represented by RSiO_{3/2} (R denotes an organic functional group) as a primary constituent unit, a liquid 1,2-polybutadiene, and a solvent.

### TECHNICAL FIELD

The present invention relates to a release agent and lubricant composition suitable for molding processing for fiber-reinforced plastics (FRP) and the like.

### BACKGROUND ART

In molding processing, release agents are used to prevent the material to be processed from adhering to tools and molds. Conventional release agents include silicone oil, perfluoropolyether, and fluororesin (polytetrafluoroethylene) powder dissolved or dispersed in a solvent, either alone or in combination, and these compounds emulsified or dispersed in water with the addition of a surfactant.

On the other hand, in the molding processing of fiber reinforced plastics (FRP), etc., so-called super engineering plastics such as polyphenylene sulfide, polyether ether ketone, aliphatic polyamide and polyamideimide are used as matrix resins from the viewpoint of improving heat resistance and mechanical strength, and the temperature during compression molding or injection molding tends to be high. In addition, in the molding processing of fiber reinforced plastics (FRP), thermosetting resins have been mainly used in the past, but due to the expansion of applications to automobiles, which require mass production, thermoplastic resins have come to be used, and the molding speed has been increased (Patent Literature 1). In addition, from the viewpoint of mass production, there is a demand for a release agent whose coating film does not deteriorate or break even when molding process is repeated. Against this background, conventional release agents have problems such as insufficient heat resistance and film damage due to high molding speed, and the material to be processed sticks to tools and molds.

As a release agent and lubricant having excellent heat resistance and repetitive molding processability, there is a release agent composition comprising a styrene-diene block copolymer, a functional silicone, a solvent, and optionally one or both of a catalyst and a crosslinking agent (Patent Literature 2). In Patent Literature 2, in order to increase the resistance of the formed coating film and improve the repetitive molding processability, the application of functional silicone and the promotion of crosslinking reaction by a catalyst or a crosslinking agent are carried out. However, although the release agent composition of Patent Literature 2 improves heat resistance, lubricity, and releasability in a one-time use, it is not sufficient to improve the repetitive molding processability. In addition, the application of functional silicone and the crosslinking reaction by a catalyst or a crosslinking agent contribute to the hardening of the formed coating film made of the release agent composition, but are not synonymous with the improvement of the adhesion of the release agent coating film to tools and molds required in repetitive molding processing, and there is a limit to repetitive molding processing. A baking type release agent for a mold in which an amino-modified silicone, a blocked polyisocyanate, and a polyol are dissolved or dispersed in a liquid can form a coating film with excellent releasability and adhesion in a short time at a baking temperature of 150° C. or less (Patent Literature 3). However, since the coating film has urethane bonds with low heat resistance, there is a problem with heat resistance during repeated molding processing.

### CITATION LIST

### Patent Literature

Patent Literature 1: JP 2014-70080 A
Patent Literature 2: JP 2009-519849 T
Patent Literature 3: JP 6869480 B

### SUMMARY OF INVENTION

### Technical Problem

An object of the present invention is to provide a release agent and lubricant composition which is excellent in lubricity and release properties, has high heat resistance, prevents seizure between a material to be processed and a mold, and exhibits good release properties between a material to be processed and a mold even after repeated molding processing.

### Solution to Problem

In the present invention, it was found that a lubricant comprising a specific silicone resin that has a high melting point and becomes a hard resin when cured, and liquid 1,2-polybutadiene forms a network structure by intramolecular and intermolecular radical polymerization reactions, and the adhesive strength of the release agent film is improved, so that the lubricant functions as a release agent and lubricant composition, and the present invention has been completed.

The release agent and lubricant composition of the present invention is characterized by comprising a silicone resin having T units represented by RSiO_{3/2} (R represents an organic functional group) as its main constituent unit, liquid 1,2-polybutadiene, and a solvent.

The molding method of the present invention is characterized by comprising step 1 of applying a release agent and lubricant composition comprising a silicone resin having T units represented by RSiO_{3/2} (R represents an organic functional group) as its main constituent unit, liquid 1,2-polybutadiene, and a solvent to a mold to form a coating film, and step 2 of heating and curing the coating film at 100 to 400° C. for 3 to 60 minutes to form a dry coating film on the surface of the mold.

The dry coating film of the present invention is characterized in that it comprises a release agent and lubricant composition comprising a silicone resin having T units represented by RSiO_{3/2} (R represents an organic functional group) as its main constituent unit, liquid 1,2-polybutadiene, and a solvent.

The release agent and lubricant composition preferably further contains a drying oil.

The content of the drying oil is preferably 20% by weight or less based on the total amount of the drying oil and the liquid 1,2-polybutadiene.

The release agent and lubricant composition preferably further contains a radical polymerization initiator.

The material to be processed may be plastic, glass, synthetic fiber, wood, rubber, stone, cement, concrete, ceramic, or a composite of two or more of these materials.

The material to be processed is particularly effective of fiber-reinforced plastics.

### Effect of the Invention

The release agent and lubricant composition of the present invention has a high adhesive strength because the lubricant, which contains a silicone resin having T units as the main constituent unit, and liquid 1,2-polybutadiene forms a network structure by intramolecular and intermolecular radical polymerization reactions. Therefore, the dry coating film formed in the mold using such a release agent and lubricant composition has high heat resistance and strength, and is not easily deteriorated or damaged even during repeated molding processing.

Furthermore, when the release agent and lubricant composition of the present invention is used in the molding processing of a material to be processed, no toxic gas is generated.

According to the present invention, the formed dry coating film has high heat resistance and strength, and is not easily deteriorated even during repeated molding processing, so that it becomes possible to mold various material to be processed. Therefore it is possible to provide a release agent and lubricant composition suitable for molding processing for the material to be processed such as plastics, glass, synthetic fibers, wood, rubber, stone, cement, concrete, ceramics, or composite materials of two or more of these, particularly fiber-reinforced plastics.

### BRIEF DESCRIPTION OF DRAWINGS

FIG. 1 is a diagram showing a method of evaluating the film strength of a release agent and lubricant composition by a reciprocating sliding friction test.

FIG. 2 is a diagram showing a method of evaluating the heat resistance of the formed film by visually confirming the transfer of the test material to the test plate during repeated molding by a press test.

### DESCRIPTION OF EMBODIMENTS

The release agent and lubricant composition of the present invention will be described in detail below.

The release agent and lubricant composition of the present invention contains a silicone resin having T units represented by RSiO_{3/2} (R represents an organic functional group) as its main constituent unit, liquid 1,2-polybutadiene, and a solvent.

Silicone resins consist of silicon bonded to organic functional groups, with the basic silicon having four bonds. The silicone backbone structure is divided into four basic units according to the number of oxygen atoms bonded to silicon (the number of 4-organic functional groups R): M units (monofunctional; RR′R″SiO_{1/2}), D units (difunctional; RR′SiO_{2/2}), T units (trifunctional; RSiO_{3/2}), and Q units (tetrafunctional; SiO_{4/2}). R is an organic functional group, and R′ and R″ are organic functional groups that contain hydrogen atoms.

Silicone resins have a structure in which the above four basic units are combined. The molecular structure is linear, cyclic, branched, or three-dimensional network structure, and T units form a three-dimensional network structure by branching or entanglement. Silicone resins comprising Q units have a branched structure, while silicone resins consisting of M units or D units are linear.

Of these, the present invention uses a silicone resin whose main constituent unit is a T unit having one organic functional group attached to silicon (hereinafter also referred to as a “T-type silicone resin”).

In the T-type silicone resin, R is an unsubstituted or substituted hydrocarbon group having 1 to 10 carbon atoms. The hydrocarbon group includes linear hydrocarbon groups and cyclic hydrocarbon groups, where the linear hydrocarbon groups are alkyl groups and alkenyl groups, etc. and the cyclic hydrocarbon groups are phenyl groups, etc. Of these, alkyl groups having no unsaturated bonds, specifically methyl groups, are preferred. Note that, within the scope of not impairing the effects of the present invention, some of the hydrogen atoms of the hydrocarbon group may be substituted with nitro groups, sulfo groups, or amino groups.

Examples of T-type silicone resins include copolymers consisting of (CH₃)₂HSiO_{1/2} units, (CH₃)₃SiO_{1/2} units, and (CH₃)SiO_{3/2} units, copolymers consisting of (CH₃)₂HSiO_{1/2} units and (CH₃)SiO_{3/2} units, and copolymers consisting of (CH₃)₂HSiO_{1/2} units, (CH₃)SiO_{3/2} units, and (C₆H₅)₃SiO_{1/2} units.

Commercially available products include X-48-1030, X-40-2756, and X-48-5030 (Silicone Resins A to C in Table 2, all manufactured by Shin-Etsu Chemical Co., Ltd.).

Liquid 1,2-polybutadiene is a polybutadiene having a vinyl type double bond. It is preferable that liquid 1,2-polybutadiene is composed only of monomer units having a vinyl type double bond. Since liquid 1,2-polybutadiene has many double bonds in the side chain, it generates a large amount of radicals, and a network structure can be formed by a polymerization reaction between the silicone resin and 1,2-polybutadiene.

The liquid 1,2-polybutadiene referred to in this specification includes, in addition to 1,2-polybutadiene, 1,2-polybutadiene glycol and those having hydrogen (—H) or hydroxyl groups (—OH) at the terminals.

The number average molecular weight (Mn) of the liquid 1,2-polybutadiene is usually 500 to 100,000, preferably 500 to 10,000, more preferably 500 to 5,000, and particularly preferably 500 to 3,000.

Commercially available products include B-1000 (terminal structure is H, number average molecular weight (Mn) is 1200, viscosity (45° C.) is 1000 mPa·s), B-3000 (terminal structure is H, number average molecular weight (Mn) is 3200, viscosity (45° C.) is 21000 mPa·s), and G-3000 (terminal structure is OH, number average molecular weight (Mn) is 3000, viscosity (45° C.) is 31000 mPa·s) (Polybutadienes A to C in Table 2, all manufactured by Nippon Soda Co., Ltd.).

In the above-mentioned release agent and lubricant composition, the content ratio of the T-type silicone resin and the liquid 1,2-polybutadiene is usually 0.2 to 2 parts by weight, preferably 0.3 to 1 part by weight, of the liquid 1,2-polybutadiene to 5 parts by weight of the T-type silicone resin.

The solvent for dissolving the T-type silicone resin and liquid 1,2-polybutadiene is not limited as long as these compounds are soluble in the solvent. For example, commercially available solvents such as propylene glycol monomethyl ether acetate (PGMAC), isohexane, dipropylene glycol dimethyl ether, 2-methylpentane, 3-methylpentane, 2,2-dimethylbutane and 2,3-dimethylbutane, toluene, xylene, ethyl acetate, butyl acetate, methyl ethyl ketone, methyl isobutyl ketone, and solvent naphtha can be used as they are. The amount of dilution with the solvent is appropriately determined depending on the film thickness (thickness of the dry film) and the coating method. The film thickness is usually 1 to 10 μm, preferably 2 to 5 μm.

In the above-mentioned release agent and lubricant composition, the T-type silicone resin and the liquid 1,2-polybutadiene undergo a reaction, specifically, a radical polymerization reaction, to form a strong inter- and intramolecular network structure, which can improve the adhesion of the release agent coating film.

The release agent and lubricant composition preferably further contains a drying oil in addition to the T-type silicone resin and the liquid 1,2-polybutadiene.

Drying oils have an iodine value (IV) of 130 or more, and are oils that take in oxygen from the air and react to form a film and solidify. The iodine value is the number of grams of iodine that can be added to 100 grams of oil or fat, and a high iodine value indicates a high content of unsaturated fatty acids.

Drying oils are, for example, linseed oil (IV 170-204) and tung oil (IV 155-175). Drying oils can generate radicals at a lower temperature than liquid 1,2-polybutadiene. This drying oil promotes the radical generation of liquid 1,2-polybutadiene, so a dry coating film can be formed even at a lower temperature.

The content of the drying oil is preferably 20% by weight or less, more preferably 5 to 20% by weight, based on the total amount of the drying oil and the liquid 1,2-polybutadiene. By comprising the drying oil in the above amount, the release agent and lubricant composition has excellent heat resistance, lubricity and releasability, and the dry coating film is less likely to deteriorate or break even after repeated molding processing. If the content of the drying oil is too high based on the total amount of the drying oil and the liquid 1,2-polybutadiene, the required coating strength may not be obtained.

The release agent and lubricant composition preferably further contains a radical polymerization initiator. The radical polymerization initiator may be either a photopolymerization initiator or a thermal polymerization initiator.

The photopolymerization initiator includes benzophenone compounds, acetophenone compounds, acylphosphine oxide compounds, titanocene compounds, oxime ester compounds, benzoin ether compounds, benzil and thioxanthone, etc. Specific examples include benzophenone, benzil dimethyl ketal, 2,2-diethoxyacetophenone, 2,2-dimethoxy-1,2-diphenylethan-1-one, 3,3-dimethyl-4-methoxybenzophenone, isoamyl p-dimethylaminobenzoate, ethyl p-dimethylaminobenzoate, p-methoxybenzophenone, 1-hydroxycyclohexylphenyl ketone, methylphenyl glyoxylate, ethylphenyl glyoxylate, 2-hydroxy-2-methyl-1-phenylpropan-1-one, and phenylbis(2,4,6-trimethylbenzoyl) phosphine oxide.

The thermal polymerization initiator includes an azo compound and an organic peroxide, etc.

Examples of azo compounds include azobisisobutyronitrile, 2,2′-azobis(2-methylpropionate)dimethyl, 2,2′-azobis(2,4-dimethylvaleronitrile), 2,2′-azobis(isobutyronitrile), 2,2′-azobis-2-methylbutyronitrile, 1,1′-azobis(1-cyclohexanecarbonitrile), 2,2′-azobis(methylisobutyrate), and 2,2′-azobis(2-amidinopropane)dihydrochloride, etc.

Examples of the organic peroxide include dicumyl peroxide, di-t-butyl peroxide, t-butyl peroxybenzoate, t-butyl hydroperoxide, benzoyl peroxide, cumene hydroperoxide, diisopropylbenzene hydroperoxide, p-menthane hydroperoxide, and di-t-butyl peroxide, etc.

The content of the radical polymerization initiator is not particularly limited, but is generally 0.01 to 0.5% by weight, preferably 0.01 to 0.1% by weight, based on the total weight of the release agent and lubricant composition. Within this range, the release agent and lubricant composition has excellent curing speed and the coating film has excellent strength. If the content of the radical polymerization initiator is too low, the effect of lowering the coating film formation temperature and the effect of shortening the reaction time cannot be fully achieved, and if the content is too high, the reaction is not promoted, resulting in no cost advantage.

The release agent and lubricant composition of the present invention is applied to the necessary parts of a mold, heated and cured to form a dry coating film, and used in molding processing of plastic, glass, synthetic fiber, wood, rubber, stone, cement, concrete, ceramic, or a composite material of two or more of these materials as the material to be processed (target material). The release agent and lubricant composition is particularly suitable for molding processing for the composite materials in which fibers such as carbon fiber and glass fiber are added to plastic to improve their strength, that is, so-called fiber-reinforced plastics (FRP).

The method for forming the dry coating film includes a step 1 of applying the release agent and lubricant composition to a mold to form a coating film, and a step 2 of heating and curing the coating film at 100 to 400° C. for 3 to 60 minutes to form a dry coating film on the surface of the mold.

A representative example of the molding process of fiber-reinforced plastics (FRP) is RTM (resin transfer molding). RTM is a molding method in which the above-mentioned FRP base material such as carbon fiber or glass fiber is placed in a mold, and then resin is injected and hardened, and it consists of a shaping process 1 and a molding process 2. In process 1, a woven fabric such as carbon fiber or glass fiber is cut into a predetermined shape, aligned in position and direction, and a preform shaped into the product shape is placed in a mold consisting of a cavity (female mold) and a core (male mold). Next, a release agent and lubricant composition is applied to the surfaces of the cavity and core of the mold, and is heated and hardened in a drying oven or direct flame to form a dry coating film in the mold. In process 2, the resin and hardener are mixed and injected into the mold at high pressure, and the resin is poured between the fibers of the preform to fill the mold with the resin, and the molded product is obtained by heating and hardening.

In addition to RTM, the molding process of fiber reinforced plastics includes autoclave molding, press molding, sheet winding molding, filament winding molding, continuous pultrusion molding, and injection molding. The release agent and lubricant composition of the present invention can be suitably used in any of the molding processes.

### EXAMPLES

The present invention will be described in more detail below based on examples and comparative examples, but the present invention is not limited to these examples.

[Evaluation of Release Agent and Lubricant composition] (1)

### Film Strength

The strength of the coating film formed from the sample release agent and lubricant composition was evaluated by a reciprocating sliding friction test shown in Table 1.

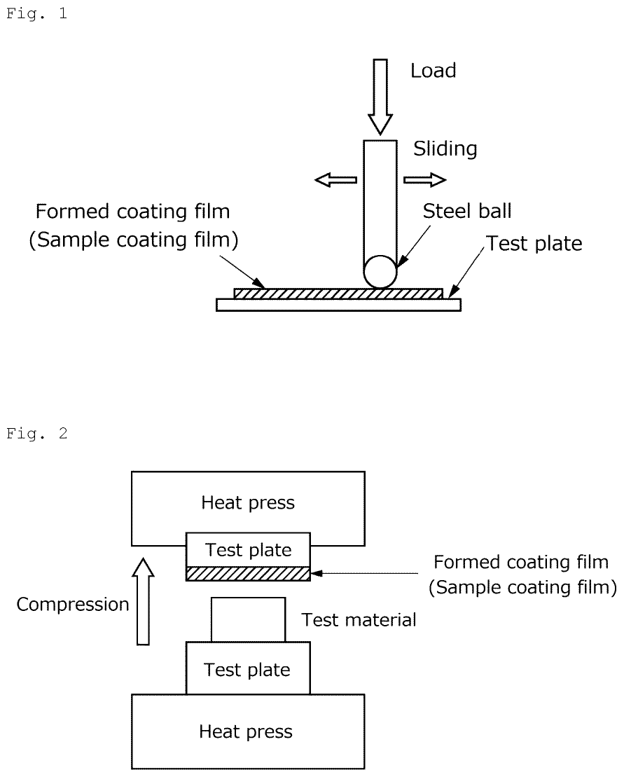

As shown in FIG. 1, the sample was applied to an SPCC-SB steel plate to a thickness of 3 to 4 μm and then dried. Samples that required heat treatment were heated under specified conditions using a siliconit electric furnace. After cooling to room temperature, a steel ball was pressed against the plate with a specified load and slid at a specified speed, as shown in FIG. 1. The number of sliding movements at which the formed coating film broke, the friction coefficient increased, and stick-slip noise occurred was used to evaluate the coating strength.

TABLE 1

| | |
|---|---|
| Testing machine | Adhesion-slip tester |
| Test plate | SPCC-SB |
| Test steel ball | SUI-J, 3/16 inch |
| Loading load | 39.2N |
| Sliding speed | 4 mm/s |
| Sliding distance | 10 mm |
| Evaluation item | Sliding frequency |

The coating strength was evaluated as follows: A for 40 or more sliding cycles, B for 30 to 39 sliding cycles, and C for less than 30 sliding cycles.

### (2) Heat Resistance

In the press test shown in FIG. 2, the presence or absence of transfer of the test material to the test plate during repeated molding was visually confirmed, and the heat resistance of the coating film formed by the release agent and lubricant composition was evaluated.

The heat press is heated to 300° C. The sample is applied to the SKD-61 test plate to a thickness of 3 to 4 μm and dried. For samples that require heat treatment, a siliconit electric furnace is used and heated under the specified conditions. Both test plates are heated to 400° C., a test material is placed on one of the test plates, the test material is sandwiched between the two test plates, pressed to a thickness of 2 mm to 1 mm, and held for 1 minute. Thermoplastic CFRP (PAN-based carbon fiber+PEEK) was used as the test material. Thereafter, the pressure is released and the test material is allowed to cool at room temperature. The presence or absence of peeling of the formed coating film from the test material is confirmed by visual inspection and finger touch, and the test is repeated until peeling is observed to evaluate the heat resistance.

Heat resistance was evaluated as follows: A for 8 molding processes, B for 4 to 7 molding processes, and C for 3 molding processes or less.

### (3) Transferability

If the release agent and lubricant composition remains after processing in an actual machine, particularly if the silicone resin remains or is transferred to the molded product, it will cause poor coating or poor adhesion of the molded product in the next process. Therefore, the amount of silicon remaining on the surface of the test material after the heat resistance evaluation test was measured using a fluorescent X-ray analysis microscope (XGT-7200, manufactured by Horiba, Ltd.) to measure the silicon peak intensity (cps/mA) and evaluate the transferability.

The transferability was rated as A when the silicon strength [cps/mA] was less than 50, B when it was 50 or more and less than 150, and C when it was 150 or more.

Note that, the comparative examples not comprising silicon were not evaluated for transferability.

### [Preparation of Release Agent and Lubricant Composition]

Samples were prepared according to the blending ratios shown in Tables 2 and 3 for Examples 1 to 18 and Test Examples 1 and 2, and in Tables 4 and 5 for Comparative Examples 1 to 11.

### Example 1

A release agent and lubricant composition was prepared by mixing 10 parts by weight of X-48-1030 (T-type silicone resin, manufactured by Shin-Etsu Chemical Co., Ltd.), 0.25 parts by weight of B-1000 (liquid 1,2-polybutadiene, manufactured by Nippon Soda Co., Ltd.), and 89.75 parts by weight of propylene glycol monomethyl ether acetate.

The release agent and lubricant composition was applied to a mold and heated at 200° C. for 20 minutes to form a dry coating film, and the film strength, heat resistance and transferability were evaluated.

The amounts of each component of the release agent and lubricant composition and the evaluation results are shown in Table 2.

### Examples 2 to 8

A release agent and lubricant composition was prepared in the same manner as in Example 1 by mixing the T-type silicone resin, liquid 1,2-polybutadiene, solvent, and other components in the types and amounts shown in Tables 2 and 3.

A dry film of the release agent and lubricant composition was formed under the same conditions as in Example 1, and the film strength, heat resistance and transferability were evaluated.

In Example 6, X-48-5030 (T-type silicone resin, Shin-Etsu Chemical Co., Ltd.) was irradiated with UV light because UV irradiation is recommended. The release agent and lubricant composition was applied to a mold and heated at 200° C. for 20 minutes, and at the same time, a black light (MidBeam 2.0) was used to irradiate with UV light (accumulated light amount 2824 (mJ/cm²)) to form a dry coating film.

### Examples 9 to 11

X-48-1030 (T-type silicone resin, manufactured by Shin-Etsu Chemical Co., Ltd.), B-1000 (liquid 1,2-polybutadiene, manufactured by Nippon Soda Co., Ltd.), linseed oil, and propylene glycol monomethyl ether acetate were mixed in the amounts shown in Tables 2 and 3 to prepare a release agent and lubricant composition.

The release agent and lubricant composition was applied to a mold, and in Example 9, it was heated at 150° C. for 20 minutes, in Example 10, it was heated at 100° C. for 60 minutes, and in Example 11, it was heated at 180° C. for 20 minutes to form a dry coating film, and the film strength, heat resistance, and transferability were evaluated.

The amounts of each component of the release agent and lubricant composition and the evaluation results are shown in Table 2 or Table 3.

### Example 12

A release agent and lubricant composition was prepared by mixing 10 parts by weight of X-48-1030 (manufactured by Shin-Etsu Chemical Co., Ltd.), 0.7 parts by weight of B-1000 (liquid 1,2-polybutadiene, manufactured by Nippon Soda Co., Ltd.), 0.3 parts by weight of linseed oil, and 89 parts by weight of propylene glycol monomethyl ether acetate.

The release agent and lubricant composition was applied to a mold and heated at 150° C. for 20 minutes to form a dry coating film, and the film strength, heat resistance and transferability were evaluated.

The amounts of each component of the release agent and lubricant composition and the evaluation results are shown in Table 3.

### Example 13

A release agent and lubricant composition was prepared by mixing 10 parts by weight of X-48-1030 (T-type silicone resin, manufactured by Shin-Etsu Chemical Co., Ltd.), 1 part by weight of B-1000 (liquid 1,2-polybutadiene, manufactured by Nippon Soda Co., Ltd.), 0.05 parts by weight of dimethyl 2,2′-azobis(2-methylpropionate) (manufactured by Tokyo Chemical Industry Co., Ltd.), and 88.95 parts by weight of propylene glycol monomethyl ether acetate.

The release agent and lubricant composition was applied to a mold and heated at 200° C. for 5 minutes to form a dry coating film, and the film strength, heat resistance and transferability were evaluated.

The amounts of each component of the release agent and lubricant composition and the evaluation results are shown in Table 3.

### Examples 14 to 16

A release agent and lubricant composition was prepared in the same manner as in Example 13, except that the types and amounts of the radical polymerization initiator and the propylene glycol monomethyl ether acetate in Example 13 were changed to those shown in Table 3.

The release agent and lubricant composition was applied to a mold, and in Example 14, it was heated at 300° C. for 5 minutes, in Example 15, it was heated at 400° C. for 3 minutes, and in Example 16, it was heated at 150° C. for 10 minutes to form a dry coating film, and the film strength, heat resistance, and transferability were evaluated.

In Example 16, the sample was heated and UV-irradiated at an integrated light quantity of 9414 (mJ/cm 2) using a black light (MidBeam 2.0).

The amounts of each component of the release agent and lubricant composition and the evaluation results are shown in Table 3.

### Example 17

A release agent and lubricant composition was prepared by mixing 10 parts by weight of X-48-1030 (T-type silicone resin, manufactured by Shin-Etsu Chemical Co., Ltd.), 0.9 parts by weight of B-1000 (liquid 1,2-polybutadiene, manufactured by Nippon Soda Co., Ltd.), 0.1 parts by weight of linseed oil, 0.05 parts by weight of phenylbis(2,4,6-trimethylbenzoyl) phosphine oxide (manufactured by Tokyo Chemical Industry Co., Ltd.), and 88.95 parts by weight of propylene glycol monomethyl ether acetate.

The release agent and lubricant composition was applied to a mold and heated at 150° C. for 5 minutes. At the same time, a black light (MidBeam 2.0) was used to irradiate the composition with UV light (accumulated light amount 4707 (mJ/cm²)) to form a dry coating film, and the film strength, heat resistance and transferability were evaluated.

The amounts of each component of the release agent and lubricant composition and the evaluation results are shown in Table 3.

### Example 18

A release agent and lubricant composition was prepared in the same manner as in Example 2, except that isohexane was used instead of propylene glycol monomethyl ether acetate.

A dry coating film of the release agent and lubricant composition was formed under the same conditions as in Example 1, and the film strength, heat resistance, and transferability were evaluated. The results are shown in Table 3.

The amounts of each component of the release agent and lubricant composition and the evaluation results are shown in Tables 2 and 3.

The release agent and lubricant compositions of Examples 1 to 18 exhibited sufficient performance in terms of film strength, transferability, and heat resistance.

TABLE 2

| | | Example | Example | Example | Example | Example | Example | Example | Example | Example | Example |
|---|---|---|---|---|---|---|---|---|---|---|---|
| | | 1 | 2 | 3 | 4 | 5 | 6 | 7 | 8 | 9 | 10 |
| Solvent | propylene glycol | 89.75 | 89.5 | 89 | 88 | 94.5 | 94.5 | 89 | 89 | 89 | 89 |
| | monomethyl | | | | | | | | | | |
| | ether acetate | | | | | | | | | | |
| | Isohexane | | | | | | | | | | |
| | n-butyl acetate | | | | | | | | | | |
| | solvent naphtha | | | | | | | | | | |
| Silicone | Silicone resin A | 10 | 10 | 10 | 10 | | | 10 | 10 | 10 | 10 |
| resin | Silicone resin B | | | | | 5 | | | | | |
| | Silicone resin C | | | | | | 5 | | | | |
| | Silicone resin D | | | | | | | | | | |
| | Silicone resin E | | | | | | | | | | |
| Polybu- | Polybutadiene A | 0.25 | 0.5 | 1 | 2 | 0.5 | 0.5 | | | 0.9 | 0.8 |
| tadiene | Polybutadiene B | | | | | | | 1 | | | |
| | Polybutadiene C | | | | | | | | 1 | | |
| | Polybutadiene D | | | | | | | | | 0.1 | 0.2 |
| Drying oil | Linseed oil | | | | | | | | | | |
| Radical | Radical | | | | | | | | | | |
| polymer- | polymerization | | | | | | | | | | |
| ization | initiator A | | | | | | | | | | |
| initiator | Radical | | | | | | | | | | |
| | polymerization | | | | | | | | | | |
| | initiator B | | | | | | | | | | |
| | Radical | | | | | | | | | | |
| | polymerization | | | | | | | | | | |
| | initiator C | | | | | | | | | | |

| | | | | | | | | | | |
|---|---|---|---|---|---|---|---|---|---|---|
| Total | 100 | 100 | 100 | 100 | 100 | 100 | 100 | 100 | 100 | 100 |
| Film formation conditions | 200*20 | 200*20 | 200*20 | 200*20 | 200*20 | 200*20 | 200*20 | 200*20 | 150*20 | 100*60 |
| (° C.*min) | | | | | | | | | | |
| Film strength | A | A | A | A | A | A | A | A | A | A |
| Heat resistance | A | A | A | A | A | A | A | A | A | A |
| Transferability | A | A | A | A | A | A | A | A | A | A |

TABLE 3

| | | | | | | | | | | Test | Terst |
|---|---|---|---|---|---|---|---|---|---|---|---|
| | | Example | Example | Example | Example | Example | Example | Example | Example | Example | Example |
| | | 11 | 12 | 13 | 14 | 15 | 16 | 17 | 18 | 1 | 2 |
| Solvent | propylene glycol | 89 | 89 | 88.95 | 88.98 | 88.95 | 88.95 | 88.95 | | 89.5 | 89.5 |
| | monomethyl | | | | | | | | | | |
| | ether acetate | | | | | | | | | | |
| | Isohexane | | | | | | | | 89.5 | | |
| | n-butyl acetate | | | | | | | | | | |
| | solvent naphtha | | | | | | | | | | |
| Silicone | Silicone resin A | 10 | 10 | 10 | 10 | 10 | 10 | 10 | 10 | 10 | 10 |
| resin | Silicone resin B | | | | | | | | | | |
| | Silicone resin C | | | | | | | | | | |
| | Silicone resin D | | | | | | | | | | |
| | Silicone resin E | | | | | | | | | | |
| Polybu- | Polybutadiene A | 0.95 | 0.7 | 1 | 1 | 1 | 1 | 0.9 | 0.5 | 0.5 | 0.5 |
| tadiene | Polybutadiene B | | | | | | | | | | |
| | Polybutadiene C | | | | | | | | | | |
| | Polybutadiene D | | | | | | | | | | |
| Drying oil | Linseed oil | 0.05 | 0.3 | | | | | 0.1 | | | |
| Radical | Radical | | | 0.05 | 0.02 | | | | | | |
| polymer- | polymerization | | | | | | | | | | |
| ization | initiator A | | | | | | | | | | |
| initiator | Radical | | | | | 0.05 | | | | | |
| | polymerization | | | | | | | | | | |
| | initiator B | | | | | | | | | | |
| | Radical | | | | | | 0.05 | 0.05 | | | |
| | polymerization | | | | | | | | | | |
| | initiator C | | | | | | | | | | |

| | | | | | | | | | | |
|---|---|---|---|---|---|---|---|---|---|---|
| Total | 100 | 100 | 100 | 100 | 100 | 100 | 100 | 100 | 100 | 100 |
| Film formation conditions | 180*20 | 150*20 | 200*5 | 300*5 | 400*3 | 150*10 | 150*5 | 200*20 | 200*20 | 200*20 |
| (° C.*min) | | | | | | | | | | |
| Film strength | A | B | A | A | A | A | A | A | A | A |
| Heat resistance | A | A | A | A | A | A | A | A | A | A |
| Transferability | A | A | A | A | A | A | A | A | A | A |

### [Evaluation Test of Resistance to Repeated Molding Processing]

The release agent and lubricant composition of Example 2 was evaluated for its resistance to repeated molding processing using concrete or general-purpose polystyrene (GPPS) as test materials.

### Test Example 1

The release agent and lubricant composition of Example 2 was applied to a formwork made of S55C (carbon steel), dried, and then heat-treated at 200° C. for 20 minutes.

A mixture of Home Jaricon (Kashima Concrete Transport Co., Ltd.) and water preliminarily mixed was poured into the formwork to a thickness of 5 mm and dried for 24 hours at 70° C. After cooling, the concrete was removed from the formwork, and the transfer state of the release agent and lubricant composition onto the concrete was visually confirmed to evaluate the durability of the coating (repeated molding).

The release agent and lubricant composition of Example 2 was able to withstand eight uses and had sufficient resistance to repeated molding processing.

### Test Example 2

As in Test Example 1, the release agent and lubricant composition of Example 2 was applied to a formwork made of S55C, dried, and then heat-treated at 200° C. for 20 minutes.

General-purpose polystyrene (GPPS) (manufactured by PS Japan Co., Ltd.) preliminarily melted at a temperature of 200° C. was poured into this formwork to a thickness of 2 mm and allowed to cool at room temperature for 24 hours. After being allowed to cool, the resin molded product was removed from the formwork and the transfer state of the release agent and lubricant composition to the resin molded product was visually confirmed to evaluate the coating durability (repeated molding processes).

The release agent and lubricant composition of Example 2 was able to withstand eight uses and had sufficient resistance to repeated molding processing.

### Comparative Example 1

A release agent composition was prepared by mixing 10 parts by weight of X-48-1030 (manufactured by Shin-Etsu Chemical Co., Ltd.) and 90 parts by weight of propylene glycol monomethyl ether acetate.

The release agent composition was applied to a mold and heated at 200° C. for 20 minutes to form a coating film, and the film strength, heat resistance and transferability were evaluated.

In the case of the release agent composition of Comparative Example 1, which did not contain liquid 1,2-polybutadiene, the coating film did not form a network structure and did not maintain sufficient film strength.

### Comparative Examples 2 and 3

The silicone resin, polybutadiene, and propylene glycol monomethyl ether acetate were mixed in the types and amounts shown in Table 4 to prepare release agent compositions.

A coating film was formed in the same manner as in Comparative Example 1, and the film strength, heat resistance and transferability were evaluated.

In Comparative Example 2, in which an MQ type silicone resin was used instead of a T type silicone resin, no effect was observed.

In Comparative Example 3, in which 1,4-polybutadiene was used instead of liquid 1,2-polybutadiene, the radical polymerization reaction did not proceed and the coating film was insufficiently cured, resulting in a rating of B for film strength and heat resistance.

### Comparative Example 4

A release agent composition was prepared by mixing 0.5 parts by weight of B-1000 (liquid 1,2-polybutadiene, manufactured by Nippon Soda Co., Ltd.), 5 parts by weight of TSF4421 (modified silicone oil, manufactured by Momentive Performance Materials Japan), and 94.5 parts by weight of isohexane.

A coating film was formed in the same manner as in Comparative Example 1, and the film strength, heat resistance and transferability were evaluated.

In Comparative Example 4, in which modified silicone oil was used instead of silicone resin, the release agent was transferred to the test material due to the oily film, and the heat resistance was poor.

### Comparative Example 5

A release agent composition was prepared by mixing 5.0 parts by weight of VISPAC 1210 (polyisobutylene, manufactured by Soken Co., Ltd.), 5.0 parts by weight of paraffinic mineral oil (kinematic viscosity 46 mm²/s, 40° C.), 80.0 parts by weight of solvent naphtha, and 10 parts by weight of X-48-1030 (T-type silicone resin, manufactured by Shin-Etsu Chemical Co., Ltd.).

A coating film was formed in the same manner as in Comparative Example 1, and the film strength, heat resistance and transferability were evaluated.

In Comparative Example 5, in which polyisobutylene, which is also a thermoplastic polymer, was used instead of liquid 1,2-polybutadiene, the hardening of the formed coating film was not promoted, and therefore the heat resistance and transferability were poor.

### Comparative Examples 6 and 7

The components shown in Table 5 were mixed to prepare release agent compositions.

The prepared release agent composition was used to form a coating film under the conditions shown in Table 5, and the film strength, heat resistance and transferability were evaluated.

The composition of Patent Literature 1 (JP 2014-70080 A) could not withstand repeated molding processing and had poor heat resistance.

### Comparative Example 8

A release agent composition was prepared by mixing 2.45 parts by weight of G-1651EU (styrene-diene block copolymer, manufactured by Kraton Corporation), 1.0 part by weight of DOWSIL RSN-6018 Resin Intermediate (manufactured by Dow Toray Co., Ltd.), 0.5 parts by weight of SILQUEST A-1122 SILANE (silane coupling agent, manufactured by Nippon Shokubai Sangyo Co., Ltd.), 0.4 parts by weight of tetrabutyl orthotitanate (manufactured by Tokyo Chemical Industry Co., Ltd.), 81.45 parts by weight of n-butyl acetate, and 14.2 parts by weight of solvent naphtha.

The prepared release agent composition was used to form a coating film under the conditions shown in Table 5, and the film strength, heat resistance and transferability were evaluated.

The composition of Patent Literature 2 (JP 2009-519849 T) was inferior in transferability and heat resistance.

### Comparative Examples 9 to 11

In Comparative Example 9, DRYFILM RA (PTFE+HFC alternative, manufactured by DuPont, USA), in Comparative Example 10, Chemlease AF-7EZ (fluorine+ silicone, manufactured by Chemtrend Japan, Inc.), and in Comparative Example 11, Chemlease HT-S (fluorine+ silicone, manufactured by Chemtrend Japan, Inc.) were used to form a coating film under the conditions shown in Table 5, and the film strength, heat resistance, and transferability were evaluated.

The commercially available release agent compositions of Comparative Examples 9 to 11 cannot carry out repeatedly molding processing. In contrast, the release agent and lubricant composition of the present invention has excellent repeated moldability.

The amounts of each component of the release agent composition and the evaluation results are shown in Tables 4 and 5.

TABLE 4

| | | Comparative | Comparative | Comparative | Comparative | Comparative |
|---|---|---|---|---|---|---|
| | | Example 1 | Example 2 | Example 3 | Example 4 | Example 5 |
| Solvent | propylene glycol | 90 | 94.5 | 89.5 | | |
| | monomethyl | | | | | |
| | ether acetate | | | | | |
| | Isohexane | | | | 94.5 | |
| | n-butyl acetate | | | | | |
| | solvent naphtha | | | | | 80 |
| Silicone | Silicone resin A | 10 | | 10 | | 10 |
| resin | Silicone resin B | | | | | |
| | Silicone resin C | | | | | |
| | Silicone resin D | | 5 | | | |
| | Silicone resin E | | | | | |
| Polybu- | Polybutadiene A | | 0.5 | | 0.5 | |
| tadiene | Polybutadiene B | | | | | |
| | Polybutadiene C | | | | | |
| | Polybutadiene D | | | 0.5 | | |
| Drying oil | Linseed oil | | | | | |
| Radical | Radical | | | | | |
| polymer- | polymerization | | | | | |
| ization | initiator A | | | | | |
| initiator | Radical | | | | | |
| | polymerization | | | | | |
| | initiator B | | | | | |
| | Radical | | | | | |
| | polymerization | | | | | |
| | initiator C | | | | | |
| Others | Silicone oil A | | | | 5 | |
| | Silicone oil B | | | | | |
| | Polyisobutylene | | | | | 5 |
| | Mineral oil A | | | | | 5 |
| | Mineral oil B | | | | | |
| | Styrene-diene | | | | | |
| | block copolymer | | | | | |
| | Silane coupling | | | | | |
| | agent | | | | | |
| | Tetrabutyl | | | | | |
| | orthotitanate | | | | | |
| Commercially | DRYFILM RA | | | | | |
| available | Chemlease AF-7EZ | | | | | |
| products | Chemlease HT-S | | | | | |

| | | | | | |
|---|---|---|---|---|---|
| Total | 100 | 100 | 100 | 100 | 100 |
| Film formation conditions | 200*20 | 200*20 | 200*20 | 200*20 | 200*20 |
| (° C.*min) | | | | | |
| Film strength | C | A | B | A | A |
| Heat resistance | B | B | B | C | C |
| Transferability | A | C | A | B | C |

TABLE 5

| | | Comparative | Comparative | Comparative | Comparative | Comparative | Comparative |
|---|---|---|---|---|---|---|---|
| | | Example 6 | Example 7 | Example 8 | Example 9 | Example 10 | Example 11 |
| Solvent | propylene glycol | | | | | | |
| | monomethyl | | | | | | |
| | ether acetate | | | | | | |
| | Isohexane | | | | | | |
| | n-butyl acetate | | | 81.45 | | | |
| | solvent naphtha | | | 14.2 | | | |
| Silicone | Silicone resin A | | | | | | |
| resin | Silicone resin B | | | | | | |
| | Silicone resin C | | | | | | |
| | Silicone resin D | | | | | | |
| | Silicone resin E | | | 1 | | | |
| Polybu- | Polybutadiene A | | | | | | |
| tadiene | Polybutadiene B | | | | | | |
| | Polybutadiene C | | | | | | |
| | Polybutadiene D | | | | | | |
| Drying oil | Linseed oil | | | | | | |
| Radical | Radical | | | | | | |
| polymer- | polymerization | | | | | | |
| ization | initiator A | | | | | | |
| initiator | Radical | | | | | | |
| | polymerization | | | | | | |
| | initiator B | | | | | | |
| | Radical | | | | | | |
| | polymerization | | | | | | |
| | initiator C | | | | | | |
| Others | Silicone oil A | | | | | | |
| | Silicone oil B | | 100 | | | | |
| | Polyisobutylene | | | | | | |
| | Mineral oil A | | | | | | |
| | Mineral oil B | 100 | | | | | |
| | Styrene-diene | | | 2.45 | | | |
| | block copolymer | | | | | | |
| | Silane coupling | | | 0.5 | | | |
| | agent | | | | | | |
| | Tetrabutyl | | | 0.4 | | | |
| | orthotitanate | | | | | | |
| Commercially | DRYFILM RA | | | | 100 | | |
| available | Chemlease AF-7EZ | | | | | 100 | |
| products | Chemlease HT-S | | | | | | 100 |

| | | | | | | |
|---|---|---|---|---|---|---|
| Total | 100 | 100 | 100 | 100 | 100 | 100 |
| Film formation conditions | — | — | — | — | 200*20 | 200*20 |
| (° C.*min) | | | | | | |
| Film strength | A | A | A | C | C | C |
| Heat resistance | C | C | B | C | C | C |
| Transferability | — | C | B | — | C | C |

In Tables 2 to 5, the materials used in Examples 1 to 18, Test Examples 1 and 2, and Comparative Examples 1 to 11 are shown below.
Silicone resin A: X-48-1030 (Shin-Etsu Chemical Co., Ltd., active ingredient: approx. 50%)
Silicone resin B: X-40-2756 (Shin-Etsu Chemical Co., Ltd.), active ingredient: 100%)
Silicone resin C: X-48-5030 (Shin-Etsu Chemical Co., Ltd.), active ingredient: 100%)
Silicone resin D: WACHER 1038 (manufactured by Wacker Asahi Kasei Silicone Co., Ltd.)
Silicone resin E: DOWSIL RSN-6018 (Resin Intermediate, manufactured by Dow Toray Co., Ltd.)
Polybutadiene A: B-1000 (liquid 1,2-polybutadiene, manufactured by Nippon Soda Co., Ltd., concentration: 98% or more, Mw=1,200, viscosity 1,000 mPa·s, 45° C.)
Polybutadiene B: B-3000 (liquid 1,2-polybutadiene, manufactured by Nippon Soda Co., Ltd., concentration: 98% or more, Mw=3,200, viscosity 21,000 mPa·s, 45° C.)
Polybutadiene C: G-3000 (liquid 1,2-polybutadiene, manufactured by Nippon Soda Co., Ltd., concentration: 98% or more, Mw=3,000, viscosity 31,000 mPa·s, 45° C.)
Polybutadiene D: POLYVEST 130 (1,4-polybutadiene, manufactured by Evonik Japan Co., Ltd., viscosity 3000 mPa·s, 20° C.)
Radical polymerization initiator A: 2,2′-azobis(2-methylpropionate)dimethyl (Tokyo Chemical Industry Co., Ltd.)
Radical polymerization initiator B: di-tert-butyl peroxide (Tokyo Chemical Industry Co., Ltd.)
Radical polymerization initiator C: phenylbis(2,4,6-trimethylbenzoyl) phosphine oxide) (manufactured by Tokyo Chemical Industry Co., Ltd.)
Silicone oil A: TSF4421 (modified silicone oil, manufactured by Momentive Performance Materials Japan)
Silicone oil B: XIAMETER SH203 (alkyl-modified silicone oil, manufactured by Dow Toray Co., Ltd.)
Polyisobutylene: VISPAC 1210 (adhesion improver, manufactured by Soken Co., Ltd.)
Mineral oil A: Paraffin-based mineral oil, equivalent to ISO VG46
Mineral oil B: Paraffin-based mineral oil, equivalent to ISO VG460
Styrene-diene block copolymer; (G-1651EU, manufactured by Kraton Corporation)
Silane coupling agent: SILQUEST A-1122 SILANE (manufactured by Nissho Sangyo Co., Ltd.)
Tetrabutyl orthotitanate: Tokyo Chemical Industry Co., Ltd.
DRYFILM RA (PTFE+HFC alternative, manufactured by DuPont, USA)
Chemlease AF-7EZ (Fluorine+Silicone, Chemtrend Japan Co., Ltd.)
Chemlease HT-S(Fluorine+Silicone, Chemtrend Japan Co., Ltd.)

1. A release agent and lubricant composition comprising a silicone resin having a T unit represented by RSiO_{3/2} (R represents an organic functional group) as a main constituent unit, liquid 1,2-polybutadiene, and a solvent.

2. The release agent and lubricant composition according to claim 1, further comprising a drying oil.

3. The release agent and lubricant composition according to claim 2, wherein the content of the drying oil is 20% by weight or less based on the total amount of the drying oil and the liquid 1,2-polybutadiene.

4. The release agent and lubricant composition according to claim 1, further comprising a radical polymerization initiator.

5. The release agent and lubricant composition according to claim 1, wherein a material to be processed is plastic, glass, synthetic fiber, wood, rubber, stone, cement, concrete, ceramic, or a composite material of two or more of these materials.

6. The release agent and lubricant composition according to claim 1, wherein a material to be processed is a fiber-reinforced plastic.

7. The method for forming a coating film comprising; step 1 of applying a release agent and lubricant composition comprising a silicone resin having T units represented by RSiO_{3/2} (R represents an organic functional group) as a main constituent unit, liquid 1,2-polybutadiene, and a solvent to a mold to form a coating film, and step 2 of heating and curing the coating film at 100 to 400° C. for 3 to 60 minutes to form a dry coating film on the surface of the mold.

8. A dry coating film comprising a release agent and lubricant composition comprising a silicone resin having T units represented by RSiO_{3/2} (R represents an organic functional group) as its main constituent unit, liquid 1,2-polybutadiene, and a solvent.
